(19) United States
(12) Patent Application Publication
(10) Pub. No.: US 2007/0159075 A1
(43) Pub. Date: Jul. 12, 2007

(54) Image display device

(76) Inventors: Terunobu Satou, Yokote (JP); Go Saitou, Mobara (JP); Toshio Tojo, Ichinomiya (JP); Tsutomu Kuniyasu, Mobara (JP)

Correspondence Address: MILBANK, TWEED, HADLEY & MCCLOY, 1 CHASE MANHATTAN PLAZA, NEW YORK, NY, 10005-1413, US

(21) Appl. No.: 11/634,603

(22) Filed: Dec. 6, 2006

(30) Foreign Application Priority Data
Dec. 9, 2005 (JP) 2005-356578

(51) Int. Cl. H01J 1/62

(52) U.S. Cl. 313/504; 313/512; 313/506

(57) ABSTRACT

In an image display device, an opening area per unit area of opening portions formed in a BM film which is formed on an inner surface of a face substrate is set such that the opening area is gradually decreased from a center portion to a peripheral portion of an image display region. By preventing the generation of color mixing in a peripheral portion of an image display region attributed to the printing position displacement of phosphor film or missing of dots in the phosphor film in pixels, it is possible to provide the image display device which can enhance a yield rate and, at the same time, can acquire an image display of high color uniformity over the whole surface of the image display region.

### BACKGROUND OF THE INVENTION

1. Field of the Invention

The present invention relates to a planar image display device which makes use of emission of electrons into vacuum formed between a face substrate and a back substrate, and more particularly to an image display device which forms phosphor films having a plurality of colors which are defined by a black matrix film on an inner surface of the face substrate.

2. Description of the Related Art

A color cathode ray tube has been popularly used conventionally as an excellent display device which exhibits high luminance and high definition. However, along with the realization of high image quality of recent information processing device and television broadcasting, there has been a strong demand for a planar image display device (flat panel display: FPD) which is light-weighted and requires a small space for installation while ensuring the excellent properties such as high luminance and high definition.

As typical examples of such a planar image display device, a liquid crystal display device, a plasma display device or the like has been put into practice. Further, particularly with respect to the planar display device which can realize the high brightness, with respect to a self luminous display device which makes use of emission of electrons into vacuum from electron sources, various planar image display devices such as an electron emission type image display device, a field emission type image display device, an organic EL display which is characterized by low power consumption and the like are expected to be put into practice in near future.

Among these planar image display devices, with respect to the self-luminous flat panel display, there has been known a display device having the constitution in which electron sources are arranged in a matrix array, wherein as one such display, there has been also known the above-mentioned electron emission type image display device which makes use of minute and integrative cold cathodes.

In the self-luminous flat panel display, as cold cathodes, thin film type electron sources of a spindle type, a surface conduction type, a carbon nanotubes type, an MIM (Metal-Insulator-Metal) type which laminates a metal layer, an insulator and a metal layer, an MIS (Metal-Insulator-Semiconductor) type which laminates a metal layer, an insulator and a semiconductor layer, a metal-insulator-semiconductor layer-metal or the like has been used.

With respect to the MIM type electron source, for example, there has been known an electron source which is disclosed in JP-A-7-65710 and JP-A-10(1998)-153979, for example. Further, with respect to the metal-insulator-semiconductor electron source, there has been known an MOS type electron source and, further, with respect to the metal-insulator-semiconductor-metal type electron source, there has been known a HEED type electron source, an EL type electron source, a porous silicon type electron source or the like.

As the FPD, there has been known a display panel which is constituted of a back substrate which includes the electron sources described above, a face substrate which includes phosphor layers and an anode electrode which forms an acceleration voltage for allowing electrons emitted from the electron sources to impinge on the phosphor layers and is arranged to face the back substrate in an opposed manner, and a sealing frame for sealing an inner space formed by opposing surfaces of both substrates into a given vacuum state. The planar image display device is operated in a state that drive circuits are combined with the display panel.

The image display device having the MIM type electron sources includes aback substrate made of an insulation material, wherein on the back substrate, a plurality of scanning signal lines which extends in one direction and is arranged in parallel in another direction which intersects one direction, and to which scanning signals are sequentially applied in another direction is formed. Further, on the substrate, a plurality of image signal lines which extends in another direction and is arranged in parallel in one direction so as to intersect the scanning signal lines is formed. The above-mentioned electron sources are respectively provided to intersecting portions of the scanning signal lines and the image signal lines, and both lines and the electron sources are connected with each other using a supply electrode thus supplying current to the electron sources.

The individual electron source forms a pair with a corresponding phosphor layer so as to constitute a unit pixel. Usually, one pixel (color pixel, pixel) is constituted of the unit pixels of three colors consisting of red (R), green (G) and blue (B). Here, in case of the color pixel, the unit pixels which constitute the respective colors are also referred to as sub pixels.

In a recent flat planner image display device, it is necessary to form a large number of minute pixel cells or electrode lines to satisfy a demand for large-sizing of a screen. In assembling a large-sized flat panel of several tens inches for manufacturing the flat planner image display device, a large number of pixel cells or a large number of electrode intersecting portions become necessary and hence, there exists various drawbacks such as the increase of a manufacturing cost of the image display device, the lowering of a yield rate and the like.

Following JP-A-6-251712 discloses a means which partially solves this type of drawback. In JP-A-6-251712, a flat panel type image display device includes at least two groups of electrodes which arrange a plurality of electrodes in the directions which intersect each other, and a planar light emitting element which includes a screen forming pixels at intersecting points arranged between the groups of electrodes, wherein an area of the pixels in a peripheral region of the screen is set larger than an area of the pixels in a center region of the screen. Due to such a constitution, the number of electrode drivers can be reduced thus facilitating the manufacture of the display device and, at the same time, the displacement of a mask can be reduced thus enhancing a yield rate of the display device.

Further, following JP-A-2003-51258 discloses a plasma display panel which has the following constitution as another means. That is, among a plurality of cells which are arranged in a matrix array, corresponding to plural pairs of display electrodes which are arranged in parallel toward upper and lower vertical ends of the panel from a panel center region, areas of cells along the respective display electrodes are gradually decreased thus setting an average cell area in the panel center region larger than an average cell area in a panel peripheral region which surrounds the panel center region. Due to such a constitution, at least one of the average cell area, an average cell numerical aperture, an average visible light transmissivity of the panel center region can be partially increased and hence, the light emission luminance of the group of cells in the region is set relatively larger than the light emission luminance of the group of cells in the panel peripheral region.

Further, in following JP-A-7-255022, a cold cathode display panel which is configured to prevent an image from appearing in a distorted manner is proposed. That is, by changing at least either one of density and size of the pixels ranging from a center portion to a peripheral portion of a display portion of a display panel, it is possible to remove eliminate a phenomenon which is generated attributed to the difference in a viewing angle between the center portion and the peripheral portion of the display portion, that is, the phenomenon in which the peripheral portion of the display portion appears in a compressed manner.

### SUMMARY OF THE INVENTION

However, this type of image display device, in manufacturing a face panel, in forming a phosphor film on an inner surface of the face substrate, the phosphor film is formed by coating by a screen printing method using a screen printing board which forms openings in conformity with opening portions formed in a black matrix film. Here, due to the elongation, the strain or the like of the screen printing board, the printing position displacement of the phosphor film occurs. This printing position displacement generates, particularly in a peripheral portion of a display region of a screen, drawbacks such as color mixing due to printing on the neighboring pixel or the missing of dots of a phosphor film in the pixels thus giving rise to drawbacks such as the lowering of a yield rate and the lowering of display quality.

The present invention has been made to overcome the above-mentioned drawbacks and it is an object of the present invention to provide an image display device which can enhance a yield rate and, at the same time, can obtain an image display of high color uniformity over a whole surface of a screen display region by preventing the color mixing in a peripheral portion of a screen display region attributed to the printing position displacement of a phosphor film or the missing of dots of the phosphor films within a pixel.

To achieve such an object, the image display device according to the present invention sets an opening area per unit area of an opening portion of a black matrix film formed on a face substrate such that the opening area is gradually decreased from a center portion to a peripheral portion of a screen display region thus increasing the tolerance with respect to the generation of color mixing attributed to the positional displacement of the phosphor film whereby the present invention can overcome the drawbacks of the related art.

Here, the present invention is not limited to the above-mentioned constitution and the constitutions of embodiments described later and various modifications are conceivable without departing from the technical concept of the present invention.

According to the image display device of the present invention, by setting the opening area per unit area of the opening portion of the black matrix film such that the opening area is gradually decreased from the center portion to the peripheral portion of a screen display region, the tolerance with respect to the generation of color mixing attributed to the positional displacement of the phosphor film formed by a printing coating method is increased and hence, color irregularities, mottling or the like in the peripheral portion of the screen display region can be eliminated. Accordingly, a yield rate can be enhanced and, at the same time, an image display having high color uniformity over the whole surface of the screen display region can be obtained and hence, it is possible to acquire an extremely excellent advantageous effect that an image display device of high quality and reliability can be obtained.

### BRIEF DESCRIPTION OF THE DRAWINGS

FIG. 1 is a plan view for explaining one embodiment of an image display device according to the present invention as viewed from a face substrate side;

FIG. 2 is a side view as viewed in the I direction in FIG. 1;

FIG. 3 is a schematic plan view of a back substrate shown by removing the face substrate shown in FIG. 1;

FIG. 4 is a schematic cross-sectional view showing the back substrate taken along a line II-II in FIG. 3 and the face substrate corresponding to the back substrate;

FIG. 5 is a schematic plan view of a BM film showing the constitution of a phosphor screen which is formed inside the face substrate in FIG. 1;

FIG. 6 is an enlarged plan view of a center portion of a display region of the BM film shown in FIG. 5;

FIG. 7 is an enlarged plan view of a peripheral portion of a display region of the BM film shown in FIG. 5;

FIG. 8 is an enlarged plan view of a peripheral portion of a display region of the BM film showing the constitution of an image display device of an embodiment 2 according to the present invention;

FIG. 9A, FIG. 9B and FIG. 9C are views for explaining an example of electron sources which constitute pixels of the image display device of the present invention, wherein FIG. 9A is a plan view, FIG. 9B is a cross-sectional view taken along a line A-A′ in FIG. 9A, and FIG. 9C is a cross-sectional view taken along a line B-B′ in FIG. 9A; and

FIG. 10 is a view of an example of an equivalent circuit of the image display device to which the constitution of the present invention is applied.

### DESCRIPTION OF THE PREFERRED EMBODIMENTS

Hereinafter, embodiments of the present invention are explained in detail in conjunction with drawings showing the embodiments.

### Embodiment 1

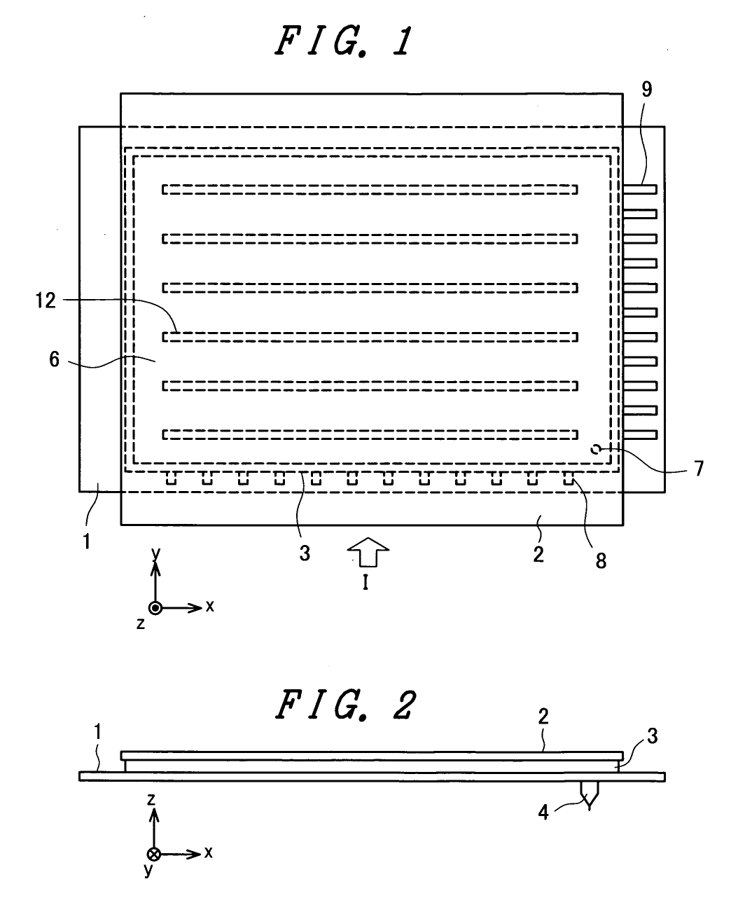

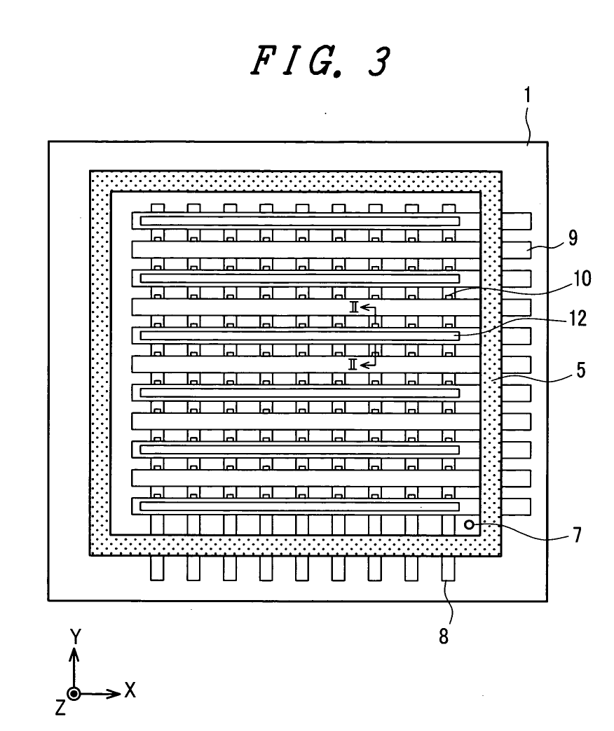

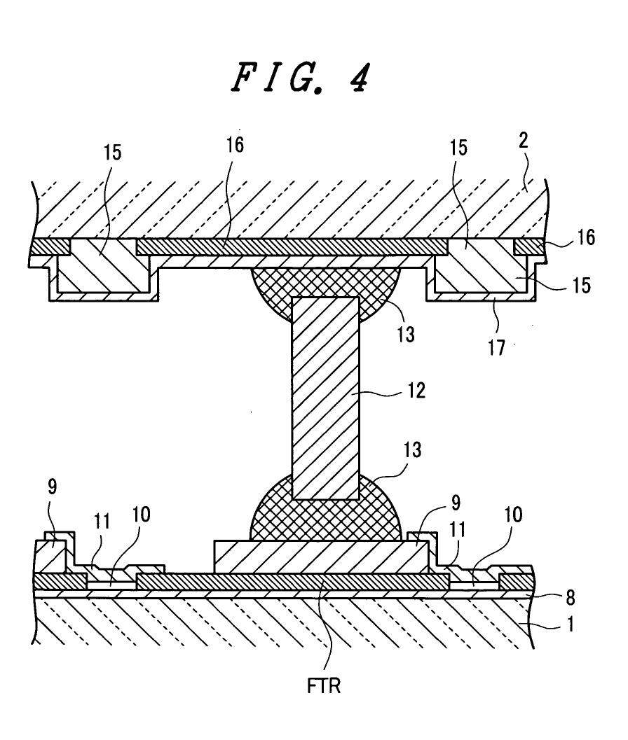

FIG. 1 to FIG. 4 are views for explaining an embodiment of an image display device according to the present invention, wherein FIG. 1 is a plan view as viewed from a face substrate side, FIG. 2 is a side view as viewed in the I direction in FIG. 1, FIG. 3 is a schematic plan view of a back substrate shown by removing the face substrate shown in FIG. 1, and FIG. 4 is a schematic cross-sectional view of a back substrate along a line II-II in FIG. 3 and a schematic cross-sectional view of a portion of the face substrate corresponding to the back substrate.

In FIG. 1 to FIG. 4, numeral 1 indicates a back substrate and numeral 2 indicates a face substrate, wherein the back substrate 1 and the face substrate 2 are formed of a glass plate having a thickness of several mm, for example, approximately 3 mm. Numeral 3 indicates a frame body which is formed of a glass plate or a sintered body made of frit glass having a thickness of several mm, for example, approximately 3 mm. Numeral 4 indicates an exhaust pipe which is fixedly secured to the back substrate 1. The frame body 3 is inserted between the back substrate 1 and the face substrate 2 in a state that the frame body 3 surrounds peripheral portions of the back substrate 1 and the face substrate 2, and the frame body 3 is hermetically sealed to the back substrate 1 and the face substrate 2 using a sealing material 5 made of, for example, frit glass. Further, the frame body 3 is arranged so as to surround an image display region 6.

A space which is surrounded by the frame body 3, the back substrate 1, the face substrate 2 and the sealing material 5 is evacuated through the exhaust pipe 4 thus holding a degree of vacuum of, for example, 10⁻³ to 10⁻⁵ Pa. Further, the exhaust pipe 4 is mounted on an outer surface of the back substrate 1 as mentioned previously and is communicated with a through hole 7 which is formed in the back substrate 1 in a penetrating manner. After completing the evacuation, the exhaust pipe 4 is sealed. Numeral 8 indicates image signal lines and the image signal lines 8 extend in Y direction and are arranged in parallel in X direction on an inner surface of the back substrate 1.

Further, numeral 9 indicates scanning signal lines and the scanning signal lines 9 extend over the image signal lines 8 in X direction which intersects the image signal lines 8 and are arranged in parallel in Y direction. Numeral 10 indicates electron sources, wherein the electron sources 10 are formed on the respective intersecting portions of the scanning signal lines 9 and the image signal lines 8, and the scanning signal lines 9 and the electron sources 10 are connected with each other by connection electrodes 11. Further, an interlayer insulation film FTR is arranged between the image signal lines 8, the electron sources 10 and the scanning signal lines 9.

Here, the image signal lines 8 are formed of an Al/Nd film, for example, while the scanning signal lines 9 are formed of an Ir/Pt/Au film or the like, for example.

Further, numeral 12 indicates spacers, wherein the spacers 12 are made of a ceramic material and are shaped in a rectangular thin plate shape, for example. In this embodiment, the spacers 12 are arranged upright above the scanning signal lines 9 every other line. The spacers 12 are usually arranged at positions which do not impede operations of pixels for every plurality of respective pixels.

Here, sizes of the spacers 12 are set based on sizes of substrates, a height of the frame body 3, materials of the substrates, an arrangement interval of the spacers, a material of spacers and the like. However, in general, the height of the spacers is approximately equal to a height of the support body 3. A thickness of the spacers 12 is set to several 10am or more and several mm or less, while a length of the spacers 12 is set to approximately 50 mm to 400 mm. Preferably, a practical value of the length of the spacers 12 is approximately 80 mm to 250 mm.

Numeral 13 indicates an adhesive material, wherein the adhesive material 13 is constituted of a conductive adhesive and the like containing, for example, a frit glass for adhesion or a vitrified component and, for example, silver. The spacers 12 are fixed to the back substrate 1 and the face substrate 2 by adhesion using the adhesive material 13. The adhesive material 13 has a thickness thereof set to ten several μm or more, preferably approximately 20 to 40 μm from a view point of ensuring the fixing by adhesion although the size may differ depending on the composition of the adhesive material 13.

On the other hand, on an inner surface of the face substrate 2, phosphor films 15 of red, green and blue are arranged in a state that these phosphor films 15 are defined by a light-blocking BM (black matrix) film 16. A metal back film (an anode electrode) 17 made of a metal thin film is formed in a state that the metal back 17 covers the phosphor films 15 and the BM film 16 thus forming a phosphor screen. Due to such phosphor screen constitution, electrons irradiated from the above-mentioned electron source 10 are accelerated and impinge on the phosphor films 15 which constitute the corresponding pixels. Accordingly, the phosphor films 15 emit light of the given color and the light is mixed with an emitted light of color of the phosphor of another pixel thus constituting the color pixel of a given color. Further, although the anode electrode 17 is indicated as a face electrode, the anode electrodes 17 also can be formed of stripe-like electrodes which are divided for every pixel column while intersecting the scanning signal lines 9.

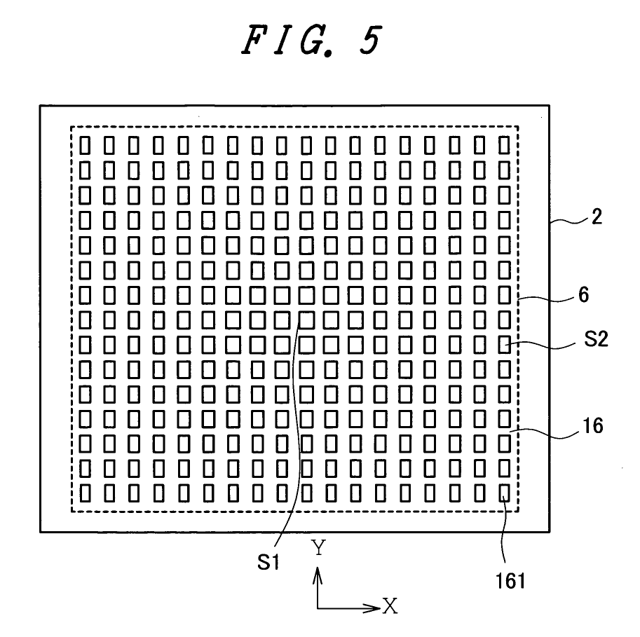

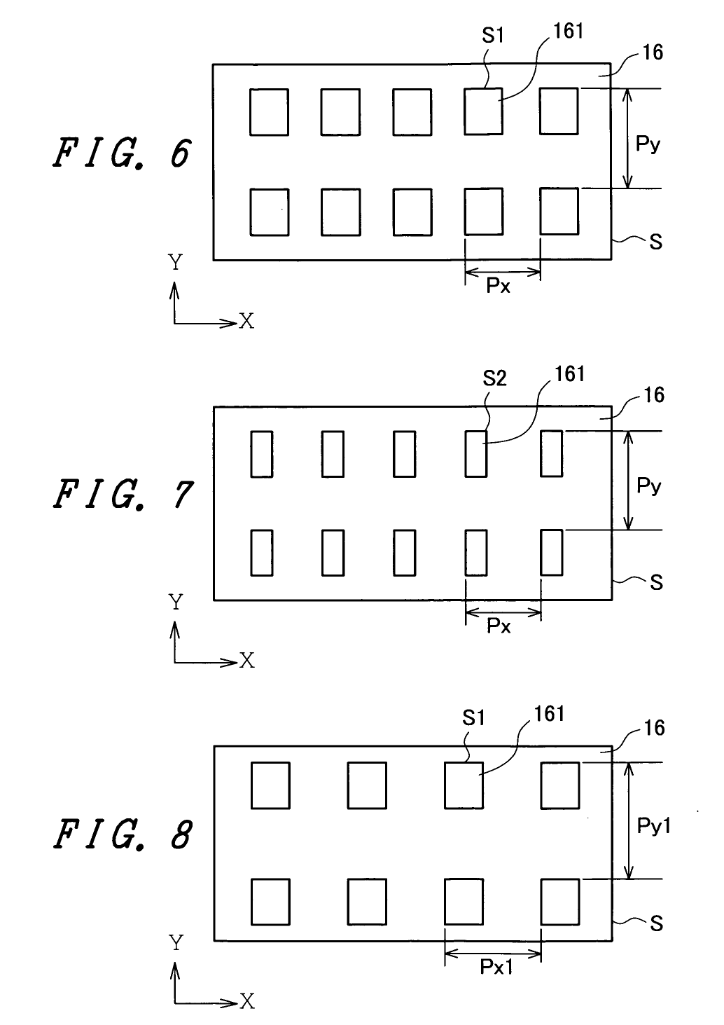

FIG. 5 to FIG. 7 are views for explaining the phosphor screen arranged inside the face substrate of the embodiment 1 of the image display device according to the present invention in FIG. 1, wherein FIG. 5 is a schematic plan view as viewed from a back-substrate side, FIG. 6 is an enlarged plan view of a center portion of a display region in FIG. 5, and FIG. 7 is an enlarged plan view of a peripheral portion of the display region in FIG. 5. In FIG. 5 to FIG. 7, the BM film 16 is formed on a portion corresponding to the display region 6 which is arranged on the face substrate 2. The BM film 16 forms a plurality of opening (window) portions 161 (in the X-Y directions of the display region 6) therein, and these opening portions 161 are formed in a state that an opening area per unit area of these opening portions 161 is gradually decreased in the direction from the center portion of the display region 6 to the peripheral portion of the display region 6. That is, a numerical aperture (opening area per unit area) of the opening portions 161 is gradually decreased in the direction from the center portion of the display region 6 to the peripheral portion of the display region 6.

FIG. 6 is a view showing the numerical aperture per unit area S in the center portion of the display region 6. The opening portion 161 having an opening area Si are arranged in the X direction at a predetermined pixel pitch Px and is arranged in the Y direction at a predetermined pixel pitch Py. On the other hand, FIG. 7 is a view showing the numerical aperture per unit area S of the opening portions 161 arranged at the peripheral portion of the display region 6. The opening portion 161 having an opening area S2 are arranged in the X direction at a predetermined pixel pitch Px in the same manner as the opening portion arranged at the center portion and is arranged in the Y direction at a predetermined pixel pitch Py. That is, the opening portions 161 are formed so as to satisfy a relationship that the opening area Si arranged at the center portion>the opening area S2 of the opening portion arranged at the peripheral portion.

Further, green phosphor films (15G), blue phosphor films (15B) and red phosphor films (15R) are formed on the respective opening portions 161 in a state that these films close the respective opening portions 161. Here, with respect to these phosphors, for example, Y₂O₂S:Eu(P22-R) may be used as the red phosphor, ZnS:Cu,Al(P22-G) may be used as the green phosphor, and ZnS:Ag,Cl(P22-B) may be used as the blue phosphor.

A metal back film 17 which is mainly made of aluminum is formed on the inner surface of the face substrate 2 by a vapor deposition method, for example, in a state that the metal back film 17 covers the BM film 16 and the phosphor films 15 formed on the inner surface of the face substrate 2. A plurality of pin holes are formed in the metal back film 17 in a penetrating manner, and the pin holes are used as gas discharge holes for a burnt gas from a background organic leveling film (filming film), the phosphor films 15 and the like.

In the phosphor screen having the above-mentioned constitution, when the electrons which are emitted from the electron source 10 formed on the back substrate 1 impinge on the phosphor film 15 after passing through the metal back film 17, phosphor particles emit light and an image is obtained by light which is radiated frontwardly from the face substrate 2.

In this embodiment, the opening area per unit area S of opening portions 161 formed in the BM film 16 which is formed on the face substrate 2 is formed such that the opening area is gradually decreased from the center portion to the peripheral portion of the image display region 6. In forming the phosphor films 15 by a screen printing method which uses a screen printing board in which openings are formed in conformity with the opening portions 161 formed in the BM film 16, it is possible to increase the tolerance with respect to the generation of missing of dots or color mixing caused by the positional displacement of the phosphor film 15 attributed to the elongation, the strain or the like of the screen printing board particularly at the peripheral portion.

### Embodiment 2

FIG. 8 is an enlarged plan view showing the constitution of a display-region peripheral portion of a phosphor screen formed on an inner side of a face substrate for explaining an embodiment 2 of the image display device according to the present invention. In the drawing, parts identical with the parts explained in conjunction with the above-mentioned drawings are given same symbols and their explanation is omitted. The constitution of a center portion of a display region 6 is equal to the corresponding constitution of the embodiment 1. In FIG. 8, a plurality of opening portions 161 which is formed in a peripheral portion of the display region 6 has an opening area S1 substantially equal to an opening area of opening portions 161 formed in the center portion. A pixel pitch px1 in the peripheral portion is set larger than a pixel pitch Px in the X direction in the center portion. Also in the Y direction, a pixel pitch Py1 in the peripheral portion is set larger than a pixel pitch Py in the center portion.

In other words, following three relationships are established, that is, the relationship that opening area S1 in the center portion=opening area S1 in the peripheral portion, the relationship that the pixel pitch Px in the center portion<the pixel pitch Px1 in the peripheral portion in the X direction, and the relationship that the pixel pitch Py in the center portion<the pixel pitch Py1 in the peripheral portion in the Y direction.

In this case, a pitch distance ranging from the pixel pitch Px in the X direction in the center portion to the pixel pitch Px1 in the X direction in the peripheral portion is gradually increased, while a pitch distance ranging from the pixel pitch Py in the Y direction in the center portion to the pixel pitch Py1 in the Y direction in the peripheral portion is also gradually increased.

Also the above-mentioned constitution adopts the structure in which a numerical aperture of the opening portions 161 (open area per unit area S) is substantially gradually decreased toward the peripheral portion from the center portion of the display region 6 and hence, it is possible to obtain advantageous effects substantially equal to the advantageous effects of the previous embodiments.

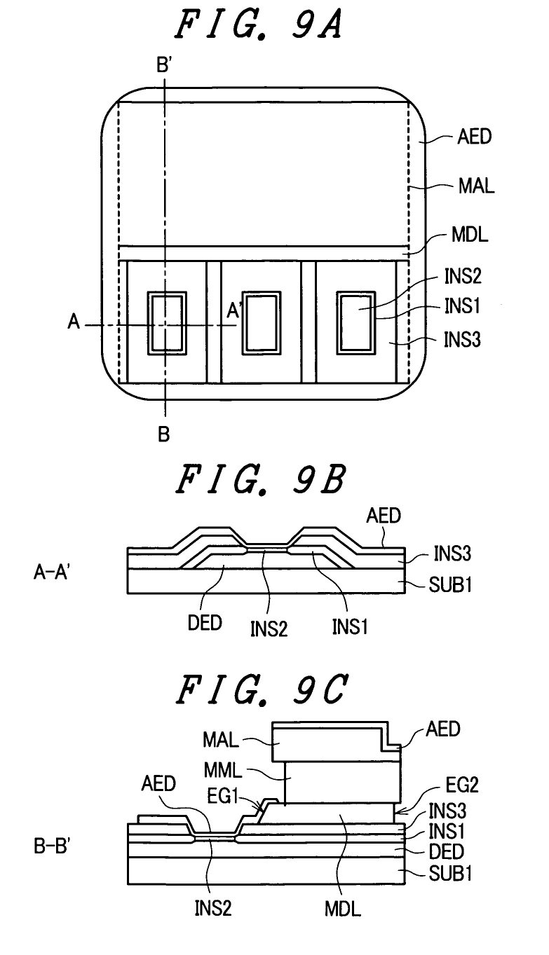

FIG. 9A, FIG. 9B and FIG. 9C are views for explaining an example of electron sources 10 which constitute pixels of the image display device of the present invention, wherein FIG. 9A is a plan view, FIG. 9B is a cross-sectional view taken along a line A-A′ in FIG. 9A, and FIG. 9C is a cross-sectional view taken along a line B-B′ in FIG. 9A. The electrons sources are formed of an MIM type electron source.

The structure of the electron source is explained in conjunction with manufacturing steps thereof. First of all, on the back substrate SUB1, lower electrodes DED (the video signal electrodes 8 in the embodiments), a protective insulation layer INS1, an insulation layer INS2 are formed. Next, an interlayer film INS3, upper bus electrodes (the scanning signal electrodes 9 in the embodiments) which become electricity supply lines to upper electrodes AED, and a metal film which constitutes a spacer electrode for arranging spacers 12 are formed by a sputtering method, for example. Although the lower electrodes and the upper electrodes are made of aluminum (Al), these electrodes are made of other metal described later.

The interlayer film INS3 may be made of silicon oxide, silicon nitride, silicon or the like, for example. Here, the interlayer film INS3 is made of silicon nitride and has a film thickness of 100 nm. The interlayer film INS3, when a pin hole is formed in a protective insulation layer INS1 formed by anodizing, fills a void and plays a role of ensuring the insulation between a lower electrode DED and an upper bus electrode (a three-layered laminated film which sandwiches copper (Cu) which constitutes a metal film intermediate layer MML between a metal film lower layer MDL and a metal film upper layer MAL) which constitutes a scanning signal electrode.

Here, the upper bus electrode AED which constitutes the scanning signal line is not limited to the above-mentioned three-layer laminated film and the number of layers may be increased more. For example, the metal film lower layer MDL and the metal film upper layer MAL may be made of a metal material having high oxidation resistance such as aluminum (Al), chromium (Cr), tungsten (W), molybdenum (Mo) or the like, an alloy containing such metal, or a laminated film of these metals. Here, the metal film lower layer MDL and the metal film upper layer MAL are made of an alloy of aluminum and neodymium (Al—Nd). Besides the alloy, with the use of a five-layered film in which the metal film lower layer MDL is a laminated film formed of an Al alloy and Cr, W, Mo or the like, the metal film upper layer MAL is a laminated film formed of chromium (Cr), tungsten (W), molybdenum (Mo) or the like and an Al alloy, and films which are brought into contact with the metal film intermediate layer MML made of Cu are made of a high-melting-point metal, in a heating step of a manufacturing process of the image display device, the high-melting-point metal functions as a barrier film thus preventing Al and Cu from being alloyed whereby the five-layered film is particularly effective in the reduction of resistance of wiring.

When the upper bus electrode is made of Al—Nd alloy, a film thickness of the Al—Nd alloy in the metal film upper layer MAL is larger than a film thickness of the Al—Nd alloy in the metal film lower layer MDL, and a thickness of Cu of the metal film intermediate layer MML is made as large as possible to reduce the wiring resistance. Here, the film thickness of the metal film lower layer MDL is approximately 300 nm, the film thickness of the metal film intermediate layer MML is approximately 4 μm, and the film thickness of the metal film upper layer MAL is approximately 450 nm. Here, Cu in the metal film intermediate layer MML can be formed by electrolytic plating or the like besides sputtering.

With respect to the above-mentioned five-layered film which uses high-melting-point metal, in the same manner as Cu, it is particularly effective to use a laminated film which sandwiches Cu with Mo which can be etched by wet etching in a mixed aqueous solution of phosphoric acid, acetic acid and nitric acid as the metal film intermediate layer MML. In this case, a film thickness of Mo which sandwiches Cu is set to approximately 50 nm, a film thickness of the Al alloy of the metal film lower layer MDL which sandwiches the metal film intermediate layer is approximately 300 nm, and the film thickness of the Al alloy of the metal film upper layer MAL which sandwiches the metal film intermediate layer is approximately 450 nm.

Subsequently, the metal film upper layer MAL is formed in a stripe shape which intersects the lower electrode DED by performing the patterning of resist by screen printing and etching. In performing the etching, for example, a mixed aqueous solution of phosphoric acid and acetic acid is used for wet etching. By excluding the nitric acid from the etchant, it is possible to selectively etch only the Al—Nd alloy without etching Cu.

Also in case of the five-layered film which uses Mo, by excluding the nitric acid from the etchant, it is possible to selectively etch only the Al—Nd alloy without etching Mo and Cu. Here, although one metal film upper layer MAL is formed per one pixel, two metal film upper layers MAL may be formed per one pixel.

Subsequently, by using the same resist film directly or using the Al—Nd alloy of the metal film upper layer MAL as a mask, Cu of the metal film intermediate layer MML is etched by wet etching using a mixed aqueous solution of phosphoric acid, acetic acid and nitric acid. Since an etching speed of Cu in the etchant made of mixed aqueous solution of phosphoric acid, acetic acid and nitric acid is sufficiently fast compared to an etching speed of the Al—Nd alloy and hence, it is possible to selectively etch only Cu of the metal film intermediate layer MML. Also in case of the five-layered film which uses Mo, the etching speeds of Mo and Cu are sufficiently fast compared to an etching speed of the Al—Nd alloy and hence, it is possible to selectively etch only the three-layered laminated film made of Mo and Cu. In etching Cu, besides the above-mentioned aqueous solution, an ammonium persulfate aqueous solution, a sodium persulfate aqueous solution can be effectively used.

Subsequently, the metal film lower layer MDL is formed in a stripe shape in which the metal film lower layer MDL intersects the lower electrode DED by performing the patterning of resist by screen printing and etching. The etching is performed by wet etching using a mixed aqueous solution of phosphoric acid and acetic acid. Here, by displacing the position of the printing resist film in the direction parallel to the stripe electrode of the metal film upper layer MAL, one side EG1 of the metal film lower layer MDL projects from the metal film upper layer MAL thus forming a contact portion to ensure the connection with the upper electrode AED in a later stage and, on another side EG2 of the metal film lower layer MDL opposite to the above-mentioned one side EG1, using the metal film upper layer MAL and the metal film intermediate layer MML as masks, the over-etching is performed and hence, a retracting portion is formed on the metal film intermediate layer MML as if eaves are formed.

Due to the eaves of the metal film intermediate layer MML, the upper electrode AED which is formed as a film in a later step is separated. Here, since the film thickness of the metal film upper layer MAL is set larger than the film thickness of the metal film lower layer MDL and hence, even when the etching of the metal film lower layer MDL is finished, it is possible to allow the metal film upper layer MAL to remain on Cu of the metal film intermediate layer MML. Due to such a constitution, it is possible to protect a surface of Cu with the metal film upper layer MAL and hence, it is possible to ensure the oxidation resistance even when Cu is used. Further, it is possible to separate the upper electrode AED in a self-aligning manner and it is possible to form the upper bus electrodes which constitute scanning signal lines which perform the supply of electricity. Further, in case that the metal film intermediate layer MML is formed of the five-layered film which sandwiches Cu with Mo, even when the Al alloy of the metal film upper layer MAL is thin, Mo suppresses the oxidation of Cu and hence, it is unnecessary to make the film thickness of the metal film upper layer MAL larger than the film thickness of the metal film lower layer MDL.

Subsequently, electron emission portions are formed as openings in the interlayer film INS3. The electron emission portion is formed in a portion of an intersecting portion of a space which is sandwiched by one lower electrode DED inside the pixel and two upper bus electrodes (a laminated film consisting of metal film lower layer MDL, metal film intermediate layer MML, metal film upper layer MAL, a laminated film consisting of metal film lower layer MDL, a metal film intermediate layer MML, and a metal film upper layer MAL of neighboring pixel not shown in the drawing) which intersects the lower electrode DED. The etching is performed by dryetching which uses an etching gas containing CF₄ and SF₆ as main components, for example.

Finally, the upper electrode AED is formed as a film. The upper electrode AED is formed by a sputtering method. The upper electrode AED may be made of Al or a laminated film made of iridium (Ir), platinum (Pt) and gold (Au), wherein a film thickness is set to approximately 6 nm, for example. Here, the upper electrode AED is, at one end portion (right side in FIG. 9C) of two pieces of upper bus electrodes which sandwich the electron emission portion (a laminated film consisting of a metal film lower layer MDL, a metal film intermediate layer MML and a metal film upper layer MAL), cut by a retracting portion (EG2) of the metal film lower layer MDL formed by the eaves structure of the metal film intermediate layer MML and the metal film upper layer MAL. Then, at another end portion (left side in FIG. 9C) of the upper bus electrodes, the upper electrode AED is formed and is connected with the upper bus electrode (the laminated film consisting of the metal film lower layer MDL, the metal film intermediate layer MML and the metal film upper layer MAL) by a contact portion (EG1) of the metal film lower layer MDL without causing a disconnection thus providing the structure which supplies electricity to the electron emission portions.

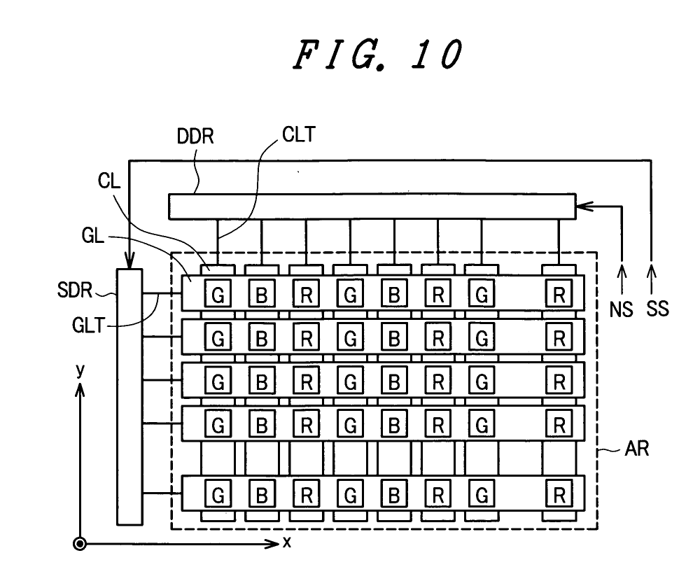

Next, FIG. 10 is an explanatory view of an example of an equivalent circuit of an image display device to which the constitution of the present invention is applied. A region depicted by a broken line in FIG. 10 indicates a display region AR. In the display region AR, n pieces of image signal electrodes 8 and m pieces of scanning signal electrodes 9 are arranged in a state that these electrodes intersect each other thus forming pixels which are arranged in a matrix array of nxm. Sub pixels are formed over the respective intersecting portions of the matrix and one group consisting of three unit pixels (or sub pixels) “R”, “G”, “B” in the drawing constitutes one color pixel. Here, the constitution of the electron sources is omitted from the drawing. The image signal electrodes (cathode electrodes) 8 are connected to the image signal drive circuit DDR through the image signal electrode lead terminals, while the scanning signal electrodes (gate electrodes) 9 are connected to the scanning signal drive circuit SDR through the scanning signal electrode lead terminal. The image signal NS is inputted to the image signal drive circuit DDR from an external signal source, while the scanning signal SS is inputted to the scanning signal drive circuit SDR in the same manner.

Due to such a constitution, by supplying the image signal to the image signal electrodes 8 which intersect the scanning signal electrodes 9 which are sequentially selected, it is possible to perform a two-dimensional full color image display. With the use of the display panel having this constitution, it is possible to realize the image display device at a relatively low voltage with high efficiency.

In the above-mentioned embodiment, the explanation has been made with respect to the case in which the present invention is applied to the display device which uses the face substrate having the phosphor layers and the black matrix film on the inner surface thereof and forming the metal back film (anode electrode) on the back surfaces of the phosphor layers and the back matrix film. However, the present invention is not limited to such a display device.

In the above-mentioned embodiments, the explanation has been made with respect to the MIM-type image display device having the cathode constitution. However, it is needless to say that the present invention is not limited to such an image display device and is applicable to image display devices of various cathode constitutions.

What is claimed is:

1. An image display device comprising:
a face substrate which includes a black matrix film in which a plurality of opening portions is formed, phosphor films of a plurality of colors in a state that the phosphor films close the opening portions, and an anode electrode which is formed of a metal thin film and covers the phosphor films and the black matrix film;
a back substrate which includes a plurality of scanning signal lines which extend in one direction and are arranged in parallel in another direction which intersects one direction, a plurality of image signal lines which extend in another direction and are arranged in parallel in one direction, and electron sources which are connected to the scanning signal lines and the image signal lines, and faces the face substrate in an opposed manner with a predetermined distance therebetween; and
a frame body which is interposed between the face substrate and the back substrate and is arranged so as to surround an image display region, wherein
a vacuum envelope of the image display device is constituted of the frame body, the face substrate and the back substrate, and
an area of the opening portion in a peripheral portion of the image display region is smaller than an area of the opening portion in a center portion of the image display region.

2. An image display device according to claim 1, wherein the opening portions are formed at an equal arrangement pitch in one direction or in another direction.

3. An image display device according to claim 1, wherein the phosphor films are arranged in a state that a distance in another direction between the neighboring phosphor films is gradually increased in the direction from the center portion of the display region to the peripheral portion of the display region.

4. An image display device according to claim 1, wherein the phosphor films are arranged in a state that the phosphor films close the opening portions and extend over the black matrix film.

5. An image display device according to claim 1, wherein each phosphor film which is formed on the face substrate is constituted of three colors consisting of red, green and blue.

6. An image display device comprising:
a face substrate which includes a black matrix film in which a plurality of opening portions is formed, phosphor films of a plurality of colors in a state that the phosphor films close the opening portions, and an anode electrode which is formed of a metal thin film and covers the phosphor films and the black matrix film;
a back substrate which includes a plurality of scanning signal lines which extend in one direction and are arranged in parallel in another direction which intersects one direction, a plurality of image signal lines which extend in another direction and are arranged in parallel in one direction, and electron sources which are connected to the scanning signal lines and the image signal lines, and faces the face substrate in an opposed manner with a predetermined distance therebetween; and
a frame body which is interposed between the face substrate and the back substrate and is arranged so as to surround an image display region, wherein
a vacuum envelope of the image display device is constituted of the frame body, the face substrate and the back substrate, and
an opening area of the opening portion arranged at a center portion of the image display region and an opening area of the opening portion arranged at a peripheral portion of the image display region are set equal to each other, and an arrangement pitch of the opening portions in the peripheral portion of the image display region is set larger than an arrangement pitch of the opening portions in the center portion of the image display region.
